(19) United States
(12) Patent Application Publication
(10) Pub. No.: US 2022/0032436 A1
(43) Pub. Date: Feb. 3, 2022

(54) Locking Ring Impactor Apparatus

(71) Applicant: Separation Equipment Co Inc, Tampa, FL (US)

(72) Inventors: Benjamin Todd Holcombe, Holly Springs, NC (US); Albert Leroy Goble, III, Valrico, FL (US)

(21) Appl. No.: 17/392,229

(22) Filed: Aug. 2, 2021

Related U.S. Application Data
(60) Provisional application No. 63/059,832, filed on Jul. 31, 2020.

(51) Int. Cl. B25D 11/02; B25D 17/00; B25D 17/24; B25D 17/28

(52) U.S. Cl. CPC B25D 11/02; B25D 17/005; B25D 2217/0073; B25D 17/28; B25D 17/24

(57) ABSTRACT

A locking ring impactor apparatus is a modular tool housing used to rotate the locking rings of centrifuges, pressure vessels, or other industrial equipment using conventional power tools. The locking ring impactor apparatus utilizes an impacting tool mounted to an armature with a recoil damper assembly. The armature receives and supports the impacting tool while the recoil damper assembly absorbs and mitigates the recoil forces generated by the impacting tool. A tool adapter is mounted between the impacting tool and a locking ring with at least one tensile member being engaged between the tool adapter and the recoil damper assembly. The at least one tensile member is configured to apply tension between the tool adapter and the recoil damper assembly to ensure that the force of the impacting tool is directed towards rotating the locking ring instead of vibrating the armature in-place.

The current application claims a priority to the U.S. Provisional Patent application Ser. No. 60/059,832 filed on Jul. 31, 2020. The current application is filed on Aug. 2, 2021 while Jul. 31, 2021 and Aug. 1, 2021 were on a weekend.

### FIELD OF THE INVENTION

The present invention relates generally to tool housings and adapter systems. More specifically, the present invention provides a novel means of adapting an impact tool to facilitate the removal of a lock ring from a centrifuge or other similar vessel.

### BACKGROUND OF THE INVENTION

High speed rotating centrifuges for material separation in process industries typically employ a heavy threaded ring or “lock ring” to hold a centrifuge assembly together. The traditional method on all major brands of centrifuges is to remove the ring with force by using a heavy sledgehammer combined with a tool that engages the ring. The tool will commonly have a bar at a larger diameter for striking in both directions, facilitating removal and reinstallation of the lock ring. A second method is also commonly used on larger centrifuges, wherein a hydraulic ram slowly presses the lock ring into position under consistent hydraulic force. The first, most common method exposes the person applying the force to injury, as well as the possibility of damaging the equipment, or articles around the equipment if the tool is missed while attempting to strike it. The second method requires a more specialized and expensive lock ring and bowl hood design to be compatible with the system and has frequent problems involving bent push pins in addition to being a relatively slow method of removal. Therefore, it is an objective of the present invention to provide a safer and cost-effective means of removing conventional lock rings associated with high-speed rotating centrifuges.

The present invention employs an impact tool such as a jackhammer, post driver, pavement breaker, or similar device as the driving force in a tool designed to remove and install lock rings on centrifuges and similar equipment where a large, threaded ring is used and typically requires more than hand forces to tighten or loosen. The novel arrangement of supporting structures and adaptive assemblies detailed herein provide a means of engaging any commonly utilized reciprocating or impact-operated tool for this purpose.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a diagram view of a methodology used to remove a centrifuge lock ring using conventional tools and techniques.

FIG. 2 is a right-side elevational view of the present invention.

FIG. 3 is an exploded view of the present invention.

FIG. 4 is a diagram view of the present invention that is mounted and installed along a centrifuge lock ring.

FIG. 5 is a diagram view of an alternate embodiment of the present invention that is mounted and installed along a centrifuge lock ring.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

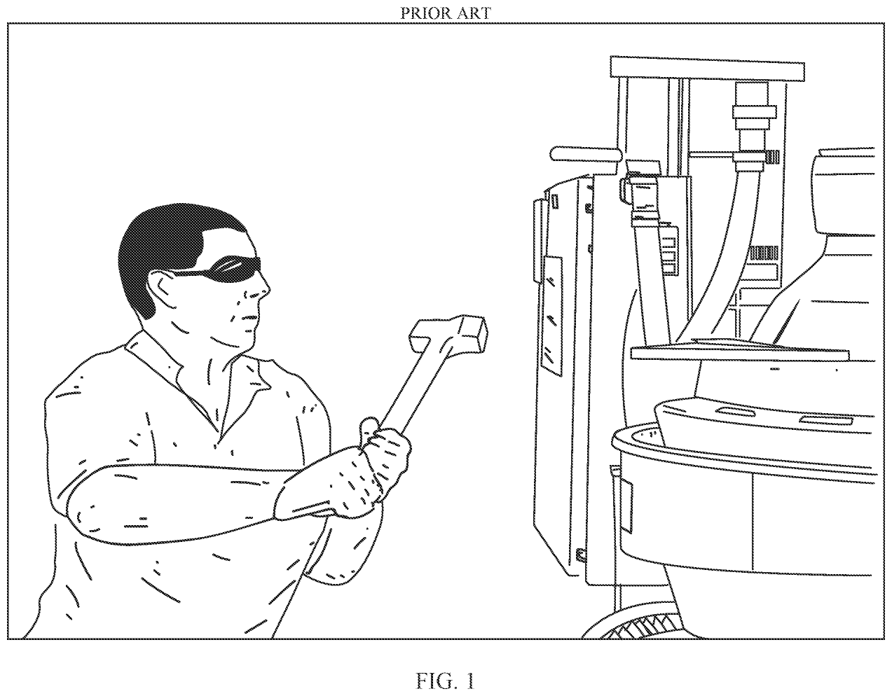

In reference to FIG. 1 through 5, the present invention is a locking ring impactor apparatus comprising an armature 10, an impacting tool 11, a recoil damper assembly 26, at least one tensile member 27, and a tool adapter 17. The armature 10 extends between a forward end 14 and a rear end 15, wherein the forward end 14 is typically oriented towards a working area or target item and the rear end 15 is proximal to a user. The armature 10 provides a substantially rigid casing of suitable dimensions to receive and support the impacting tool 11. The impacting tool 11 is mounted to the armature 10 between the forward end 14 and the rear end 15 as a modular, interchangeable component of the present invention. More specifically, the impacting tool 11 broadly refers to any type of impact-generating, reciprocating, or vibratory implement that may be effective in locking or unlocking of a lock ring. Accordingly, any embodiment of the impacting tool 11 may be interchanged from the armature 10 for any other comparable implement without departing from the spirit or scope of the present invention.

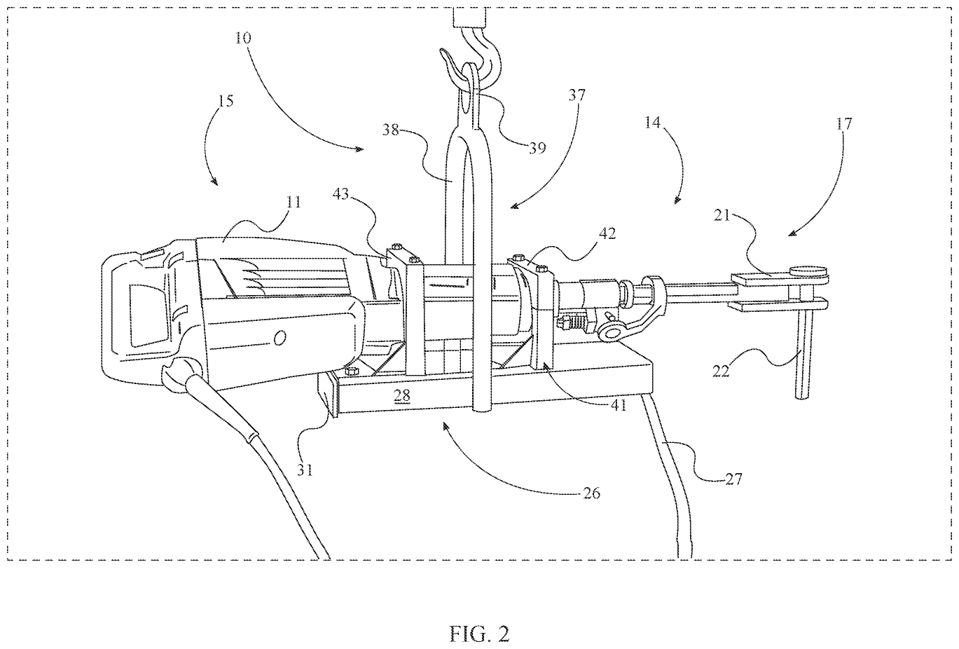

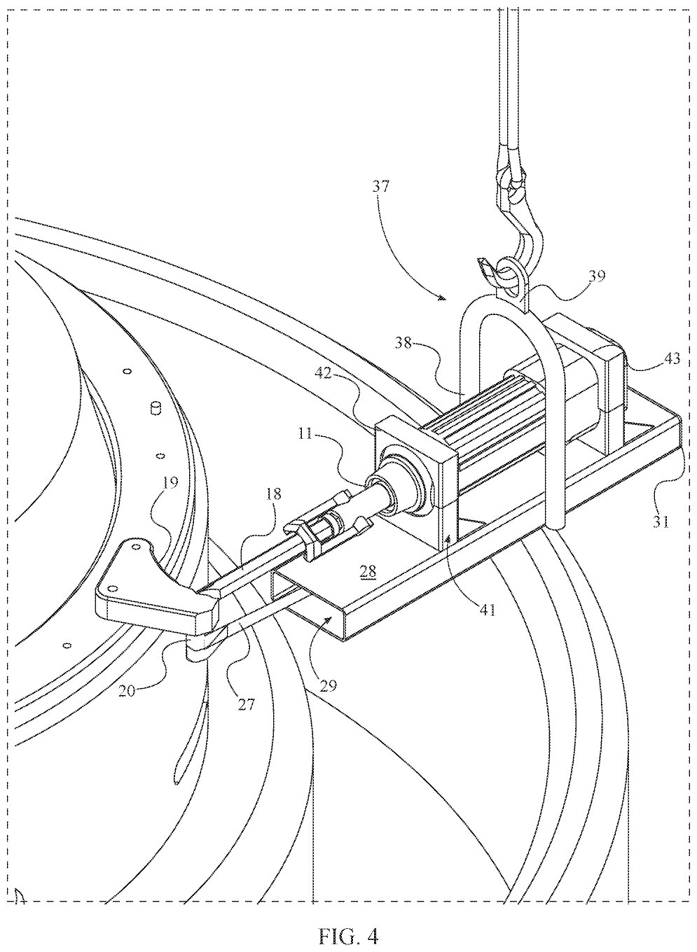

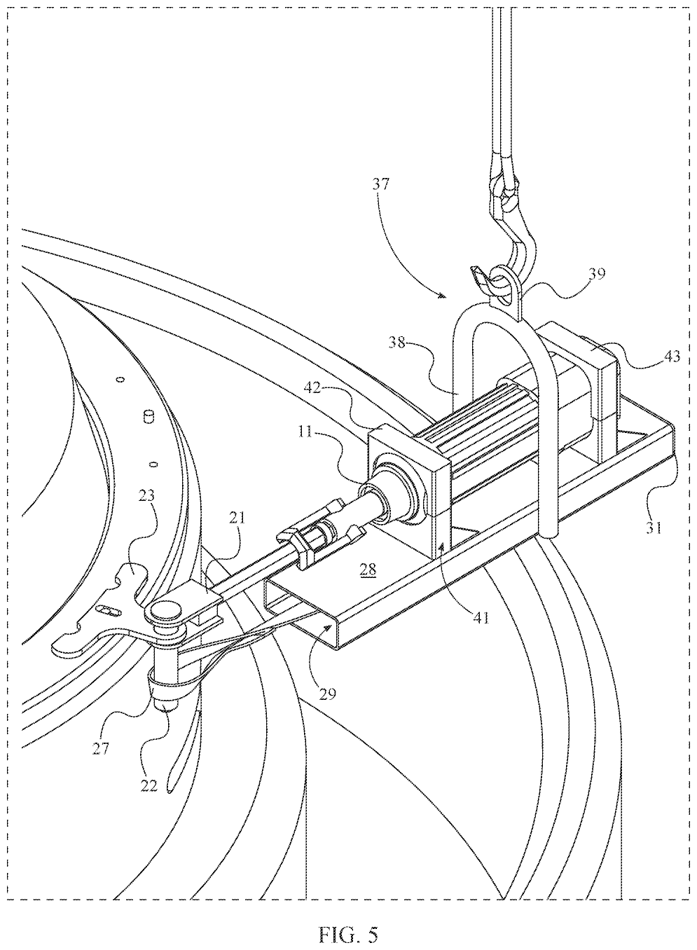

In reference to FIGS. 4 and 5, the impacting tool 11 is supported to counteract the recoil forces imparted to the operator. This is not conventionally an issue, as typically uses of the impacting tool 11 (e.g., jackhammer, post driver, pavement breaker) are oriented upright with a constant gravity ‘assist’ to maintain contact with said working surface. In reference to FIG. 2, the impacting tool 11 must function in an orthogonal orientation, thereby necessitating the recoil damper assembly 26 and the at least one tensile member 27 to provide an equivalent of the gravity assist in-line with the new orientation. Accordingly, the recoil damper assembly 26 is engaged to the tool armature 10.

The tool adapter 17 is mounted to the impacting tool 11, adjacent to the forward end 14 of the armature 10. The tool adapter 17 provides a means for impacting tool 11 to engage with any locking ring to impart force along a tangent vector to the locking ring, i.e., rotating the locking ring. Further, the tool adapter 17 provides a means for the impacting tool 11 to effectively engage with any locking ring or comparable working surface across a variety of conceivable embodiments. Like the impacting tool 11, the tool adapter 17 is proposed as a modular component to enable the successful engagement of the present invention against any suitable external assembly.

At least one tensile member 27 is engaged between the tool adapter 17 and the recoil damper assembly 26, wherein the at least one tensile member 27 is configured to apply tension between the tool adapter 17 and the recoil damper assembly 26. As shown in FIGS. 4 and 5, the at least one tensile member 27 completes the engagement of the recoil damper assembly 26 to a static element to the fore of the impacting tool 11, thereby enabling the recoil damper assembly 26 to counteract any recoil forces transmitted through the armature 10. In the preferred embodiment, the tension between at least one tensile member 27 and the recoil damper assembly 26 is configured to simulate conventional working conditions (i.e., upright with a gravity assist) for the impacting tool 11.

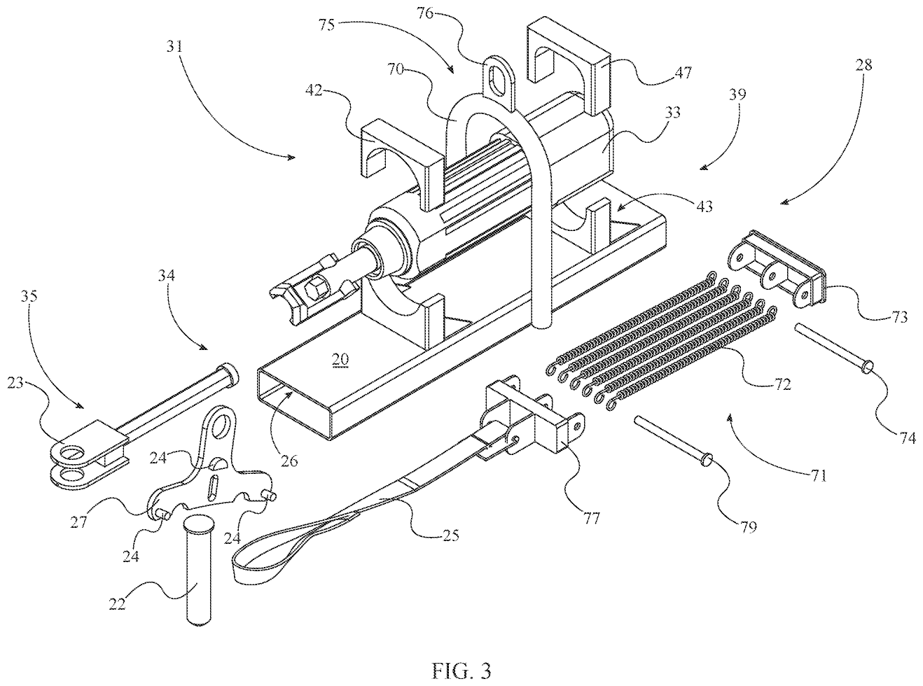

In reference to FIG. 3, the recoil damper assembly 26 further comprises a housing 28, a channel 29, and a damper 30. The housing 28 is mounted to the armature 10 between the forward end 14 and the rear end 15 with the channel 29 traversing the housing 28 between the forward end 14 and the rear end 15. The housing 28 provides a rigid protective shell for the damper 30 and defines the dimensions of the channel 29, wherein the channel 29 roughly constitutes the stroke of the damper 30. More specifically, the damper 30 is mounted into the channel 29, wherein the damper 30 defines a flexible, compressible, extensible, or otherwise deformable element suitable to provide counterforce to the motion of the impacting tool 11.

In at least one embodiment, the damper 30 further comprises a base plate 31, a plurality of elastic elements 32, and a piston 33. As shown in FIGS. 2 and 3 the base plate 31 is mounted to the housing 28 adjacent to the rear end 15, enclosing the channel 29 to the rear and providing a fixed point through which the plurality of elastic elements 32 exerts force against the armature 10. Opposite the base plate 31, the piston 33 remains mobile within the channel 29 to allow for recoil forces to be adsorbed before said force is transferred into the armature 10. More specifically, the piston 33 is slidably mounted into the channel 29, wherein the piston 33 traverses between the forward end 14 and the base plate 31 under tension from the plurality of elastic elements 32. Accordingly, the plurality of elastic elements 32 is mounted between the base plate 31 and the piston 33, wherein the plurality of elastic elements 32 is configured to force the piston 33 toward the rear end 15. This rearward bias creates a force in opposition to the recoil force generated by the impacting tool 11, thereby maintaining the armature 10 in equilibrium between the opposed forces.

In at least one embodiment of the present invention, the impacting tool 11 is reconfigured or exchanged for an embodiment capable of generating greater or lesser impacting force. Accordingly, the resultant recoil forces exerted against the recoil damper assembly 26 vary, and the damper 30 is therefore required to compensate for varying exerted forces. It is therefore proposed that the plurality of elastic elements 32 constitutes an interchangeable component of the present invention to accommodate the modularity of the impacting tool 11. As shown in FIG. 3, the damper 30 further comprises a primary retainer 34 and a secondary retainer 35. The primary retainer 34 and the secondary retainer 35 broadly refer to any type of releasable of removeable fastener suitable for bearing the forces exerted by the plurality of elastic elements 32. The primary retainer 34 is removably engaged between the plurality of elastic elements 32 and the base plate 31 and the secondary retainer 35 is removably engaged between the plurality of elastic elements 32 and the piston 33. Removal of both the primary and secondary retainer 35 disengages the plurality of elastic elements 32 from the recoil damper assembly 26, thereby enabling the exchange or adjustment of the damper 30 to accommodate any embodiment of the impacting tool 11.

The exchange of the impacting tool 11 for various alternate embodiments of the impacting tool 11 requires the armature 10 to release the impacting tool 11 from a normally static position. In reference to FIGS. 2 and 3, the armature 10 further comprises a support frame 37 and at least one mounting block 41. The at least one mounting block 41 constitutes any type or variety of releasable fastening assembly suitable for retaining the impacting tool 11 in a static position relative to the recoil damper assembly 26. More specifically, the at least one mounting block 41 is mounted to the recoil damper assembly 26 between the forward end 14 and the rear end 15, wherein the impacting tool 11 is removably positioned within the at least one mounting block 41. Further, the support frame 37 is connected to the recoil damper assembly 26 around the impacting tool 11 between the forward end 14 and the rear end 15. The position of the support frame 37 around the impacting tool 11 provides a suitable handhold for an operator to maneuver the present invention separate from the mounting block, thereby minimizing the risk of an operator accidentally releasing the impacting tool 11 during use.

In one embodiment of the present invention, the at least one mounting block 41 comprises a first collar 42 and a second collar 43 as shown in FIG. 2. The first collar 42 and the second collar 43 both define adjustable band-clamps or halved pillow blocks of suitable dimensions to receive any type or variety of impacting tool 11, as previously outlined. The first collar 42 is positioned adjacent to the forward end 14 and the second collar 43 is positioned adjacent to the rear end 15, wherein the impacting tool 11 is releasably mounted between the first collar 42 and the second collar 43. The offset positions of the first collar 42 and the second collar 43 minimize the opportunity for the impacting tool 11 to deflect between the forward end 14 and the rear end 15, ensuring that the force of the impacting tool 11 is exerted directly into the tool adapter 17. In one further embodiment, the support frame 37 also comprises a handle loop 38 and at least one external mount 39. The handle loop 38 extends perpendicular to the recoil damper assembly 26, wherein the impacting tool 11 is positioned within the handle loop 38. The extension of the handle loop 38 around the impacting tool 11 ensures that an operator can maintain control of the present invention from any angle without reaching into the path of any operating machinery, reducing the likelihood of injury for the operator. The at least one external mount 39 is connected to the handle loop 38 to provide a dedicated attachment point for any external weight-bearing structure. As shown in FIGS. 4 and 5, the at least one external mount 39 is configured to receive a chain hook, thereby enabling the present invention to be suspended from an overhead crane or rail system. In at least one alternate embodiment, the at least one external mount 39 is configurable to attach to an articulated arm, rolling trolley, or any other equipment carrier as may be realized by a reasonably skilled individual.

As outlined above, the tool adapter 17 is broadly contemplated to enable the engagement of the impacting tool 11 to a locking ring utilizing any suitable means as might be realized by a reasonably skilled individual. In one embodiment, the tool adapter 17 comprises a tool head 18, a striking surface 19, and at least one tensioning mount 20. The tool head 18 is mounted to the impacting tool 11 adjacent to the forward end 14 of the armature 10 and the striking surface 19 is configured to receive the tool head 18. In this embodiment, the tool head 18 may define any conventional tooling (chisel, spike, etc.) that may be found on any heavy-use embodiment of the impacting tool 11 (e.g., jackhammers, pavement breakers). As shown in FIG. 4, the striking surface 19 defines a target region of the lock ring (or other comparable structure) configured to sustain and redirect the impact force of the tool head 18. At least one tensioning mount 20 is positioned adjacent to the striking surface 19 and the at least one tensile member 27 is engaged to the tensioning mount, thereby enabling the function of the recoil damper assembly 26 as previously outlined. The use of conventional tooling precludes the need for any specialized equipment to be attached to the impacting tool 11 for use in this application, reducing setup and changeover costs for a non-dedicated embodiment of the impacting tool 11.

In another embodiment, the tool adapter 17 comprises a clevis 21, an arbor 22, a flange plate 23, and a plurality of engagement members 24. As shown in FIG. 5, the clevis 21 is mounted to the impacting tool 11 adjacent to the forward end 14 of the armature 10. The flange plate 23 is further mounted into the clevis 21 with the arbor 22, wherein the flange plate 23 is configured to rotate about the arbor 22. This arrangement enables an operator to adjust the orientation of the impacting tool 11 about the arbor 22 without reconfiguring or detaching any portion of the present invention. In practice, this enables the operator to rapidly switch directions to remove or tighten a lock ring by pivoting the armature 10 and impacting tool 11 about the tool adapter 17. The at least one tensile member 27 is engaged about the arbor 22 to enable the recoil damper assembly 26 to remain in tension with the tool adapter 17 throughout the pivoting motion. This precludes any additional reconfiguration of the at least one tensile member 27 once the present invention is configured for use. The plurality of engagement members 24 extend from the flange plate 23, wherein the plurality of engagement members 24 is configured to perimetrically mount to an external adjustment element 12. The plurality of engagement members 24 generally refers to any mechanical engagement system as may be recognized in the field. Likewise, the external adjustment element 12 broadly refers to any compatible mounting point or service mount typically found on any locking ring.

Although the invention has been explained in relation to its preferred embodiment, it is to be understood that many other possible modifications and variations can be made without departing from the spirit and scope of the invention as hereinafter claimed.

What is claimed is:

1. A locking ring impactor apparatus comprising:
an armature;
an impacting tool;
a recoil damper assembly;
at least one tensile member;
a tool adapter;
the armature extending between a forward end and a rear end;
the impacting tool being mounted to the armature between the forward end and the rear end;
the recoil damper assembly being engaged to the tool armature;
the tool adapter being mounted to the impacting tool, adjacent to the forward end of the armature; and
at least one tensile member being engaged between the tool adapter and the recoil damper assembly, wherein the at least one tensile member is configured to apply tension between the tool adapter and the recoil damper assembly.

2. The locking ring impactor apparatus as claimed in claim 1 comprising:
the recoil damper assembly further comprising a housing, a channel, and a damper;
the housing being mounted to the armature between the forward end and the rear end;
the channel traversing the housing between the forward end and the rear end; and
the damper being mounted into the channel.

3. The locking ring impactor apparatus as claimed in claim 2 comprising:
the damper further comprising a base plate, a plurality of elastic elements, and a piston;
the base plate being mounted to the housing adjacent to the rear end;
the piston being slidably mounted into the channel, wherein the piston traverses between the forward end and the base plate under tension from the plurality of elastic elements; and
the plurality of elastic elements being mounted between the base plate and the piston, wherein the plurality of elastic elements is configured to force the piston toward the rear end.

4. The locking ring impactor apparatus as claimed in claim 3 comprising:
the damper further comprising a primary retainer and a secondary retainer;
the primary retainer being removably engaged between the plurality of elastic elements and the base plate; and
the secondary retainer being removably engaged between the plurality of elastic elements and the piston.

5. The locking ring impactor apparatus as claimed in claim 1 comprising:
the armature further comprising a support frame and at least one mounting block;
the at least one mounting block being mounted to the recoil damper assembly between the forward end and the rear end, wherein the impacting tool is removably positioned within the at least one mounting block; and
the support frame being connected to the recoil damper assembly around the impacting tool between the forward end and the rear end.

6. The locking ring impactor apparatus as claimed in claim 5 comprising:
the at least one mounting block comprising a first collar and a second collar;
the first collar being positioned adjacent to the forward end;
the second collar being positioned adjacent to the rear end; and
the impacting tool being releasably mounted between the first collar and the second collar.

7. The locking ring impactor apparatus as claimed in claim 5 comprising:
the support frame further comprising a handle loop and at least one external mount;
the handle loop extending perpendicular to the recoil damper assembly, wherein the impacting tool is positioned within the handle loop; and
the at least one external mount being connected to the handle loop.

8. The locking ring impactor apparatus as claimed in claim 1 comprising:
the tool adapter further comprising a tool head, a striking surface, and at least one tensioning mount;
the tool head being mounted to the impacting tool adjacent to the forward end of the armature;
the striking surface being configured to receive the tool head;
at least one tensioning mount being positioned adjacent to the striking surface; and
the at least one tensile member being engaged to the tensioning mount.

9. The locking ring impactor apparatus as claimed in claim 1 comprising:
the tool adapter further comprising a clevis, an arbor, a flange plate, and a plurality of engagement members;
the clevis being mounted to the impacting tool adjacent to the forward end of the armature;
the flange plate being mounted into the clevis with the arbor, wherein the flange plate is configured to rotate about the arbor;
the at least one tensile member being engaged about the arbor; and
the plurality of engagement members extending from the flange plate, wherein the plurality of engagement members is configured to perimetrically mount to an external adjustment element.

10. A locking ring impactor apparatus comprising:
an armature;
an impacting tool;
a recoil damper assembly;
at least one tensile member;
a tool adapter;
the armature extending between a forward end and a rear end;
the impacting tool being mounted to the armature between the forward end and the rear end;
the recoil damper assembly being engaged to the tool armature;
the tool adapter being mounted to the impacting tool, adjacent to the forward end of the armature;
at least one tensile member being engaged between the tool adapter and the recoil damper assembly, wherein the at least one tensile member is configured to apply tension between the tool adapter and the recoil damper assembly;
the recoil damper assembly further comprising a housing, a channel, and a damper;
the housing being mounted to the armature between the forward end and the rear end;
the channel traversing the housing between the forward end and the rear end; and
the damper being mounted into the channel.

11. The locking ring impactor apparatus as claimed in claim 10 comprising:
the damper further comprising a base plate, a plurality of elastic elements, and a piston;
the base plate being mounted to the housing adjacent to the rear end;
the piston being slidably mounted into the channel, wherein the piston traverses between the forward end and the base plate under tension from the plurality of elastic elements; and
the plurality of elastic elements being mounted between the base plate and the piston, wherein the plurality of elastic elements is configured to force the piston toward the rear end.

12. The locking ring impactor apparatus as claimed in claim 11 comprising:
the damper further comprising a primary retainer and a secondary retainer;
the primary retainer being removably engaged between the plurality of elastic elements and the base plate; and
the secondary retainer being removably engaged between the plurality of elastic elements and the piston.

13. The locking ring impactor apparatus as claimed in claim 10 comprising:
the armature further comprising a support frame and at least one mounting block;
the at least one mounting block being mounted to the recoil damper assembly between the forward end and the rear end, wherein the impacting tool is removably positioned within the at least one mounting block; and
the support frame being connected to the recoil damper assembly around the impacting tool between the forward end and the rear end.

14. The locking ring impactor apparatus as claimed in claim 13 comprising:
the at least one mounting block being a first collar and a second collar;
the first collar being positioned adjacent to the forward end;
the second collar being positioned adjacent to the rear end; and
the impacting tool being releasably mounted between the first collar and the second collar.

15. The locking ring impactor apparatus as claimed in claim 13 comprising:
the support frame further comprising a handle loop and at least one external mount;
the handle loop extending perpendicular to the recoil damper assembly, wherein the impacting tool is positioned within the handle loop; and
the at least one external mount being connected to the handle loop.

16. The locking ring impactor apparatus as claimed in claim 10 comprising:
the tool adapter further comprising a tool head, a striking surface, and at least one tensioning mount;
the tool head being mounted to the impacting tool adjacent to the forward end of the armature;
the striking surface being configured to receive the tool head
at least one tensioning mount being positioned adjacent to the striking surface; and
the at least one tensile member being engaged to the tensioning mount.

17. The locking ring impactor apparatus as claimed in claim 10 comprising:
the tool adapter further comprising a clevis, an arbor, a flange plate, and a plurality of engagement members;
the clevis being mounted to the impacting tool adjacent to the forward end of the armature;
the flange plate being mounted into the clevis with the arbor, wherein the flange plate is configured to rotate about the arbor;
the at least one tensile member being engaged about the arbor; and
the plurality of engagement members extending from the flange plate, wherein the plurality of engagement members is configured to perimetrically mount to an external adjustment element.
